(19) United States
(12) Patent Application Publication
(10) Pub. No.: US 2018/0077477 A1
(43) Pub. Date: Mar. 15, 2018

(54) POROUS AUDIO DEVICE HOUSING

(71) Applicant: Nokia Technologies Oy, Espoo (FI)

(72) Inventors: MIIKKA T. VILERMO, Siuro (FI); Antero J. TOSSAVAINEN, Oulu (FI)

(73) Assignee: Nokia Technologies Oy

(21) Appl. No.: 15/266,049

(22) Filed: Sep. 15, 2016

(51) Int. Cl. H04R 1/02; H04R 3/04; H04R 3/00

(52) U.S. Cl. CPC H04R 1/025; H04R 3/04; H04R 2410/07; H04R 1/023; H04R 2499/11; H04R 3/005

(57) ABSTRACT

An apparatus comprises a housing, the housing having a porosity comprising pores that are substantially non-discernible to a user such that sound waves from an outside of the housing can be received at an inside of the housing; at least one microphone located at the inside of the housing and configured to receive the sound waves via acoustic connection to the outside of the housing; a processor for processing the sound waves received by the at least one microphone; and a memory for storing the processed sound waves as a file. The at least one microphone is not mechanically coupled to the pores.

### BACKGROUND

### Technical Field

The exemplary and non-limiting embodiments described herein relate generally to mobile devices capable of capturing audio and, more particularly, to mobile devices (cameras, virtual reality cameras, tablets, mobile phones, and the like) that employ porous materials through which audio may be captured.

### Brief Description of Prior Developments

The integration of microphones into an electronic device to capture sound generally requires the use of holes in a housing or a cover of the electronic device. Sound is received through the holes and is picked up by a microphone within the housing. Such holes, in addition to detracting from the aesthetic qualities of the electronic device, attract foreign objects (such as dust) and humidity that may compromise the operation of the microphone. Furthermore, a user of the electronic device may inadvertently obstruct the holes during use (e.g., by placing their hand over the holes), which may cause a less than optimal pickup of sound by the microphone or block the sound pickup altogether. Moreover, during use of such an electronic device, noise from wind and handling by the user may also detrimentally affect audio quality.

### SUMMARY

The following summary is merely intended to be exemplary. The summary is not intended to limit the scope of the claims.

In accordance with one exemplary aspect, an apparatus comprises a housing, the housing having a porosity comprising pores that are substantially non-discernible to a user such that sound waves from an outside of the housing can be received at an inside of the housing; at least one microphone located at the inside of the housing and configured to receive the sound waves via acoustic connection to the outside of the housing; a processor for processing the sound waves received by the at least one microphone; and a memory for storing the processed sound waves as a file. The at least one microphone is not mechanically coupled to the pores.

In accordance with another exemplary aspect, an apparatus comprises at least one processor; and at least one non-transitory memory including computer program code, the at least one memory and the computer program code configured to, with the at least one processor, cause the apparatus at least to perform: detecting a sound from a first side of a porous material comprising pores that are substantially non-discernible to a user through the porous material at an opposing second side of the porous material; receiving the sound into at least one microphone at the opposing second side of the porous material via acoustic connection to the first side of the porous material; and processing the received sound at the at least one processor. The at least one microphone is not mechanically coupled to the pores.

In accordance with another exemplary aspect, a method comprises detecting a sound from a first side of a porous material comprising pores that are substantially non-discernible to a user through the porous material at an opposing second side of the porous material; receiving the sound into at least one microphone at the opposing second side of the porous material via acoustic connection to the first side of the porous material; and processing the received sound at the at least one processor. The at least one microphone is not mechanically coupled to the pores.

### BRIEF DESCRIPTION OF THE DRAWINGS

The foregoing aspects and other features are explained in the following description, taken in connection with the accompanying drawings, wherein:

FIG. 1 is a schematic representation of one exemplary embodiment of a housing of an electronic device employing a microphone configuration;

FIG. 2 is a cutaway view of a microphone housing on the inside of the electronic device;

FIG. 3 is a perspective view of the inside of the housing of the electronic device showing a flexible connection;

FIG. 4 is a schematic representation of sound holes in the housing of the electronic device;

FIG. 5 is a schematic representation of another exemplary embodiment of an apparatus employing a porous material as a housing and having two microphones;

FIG. 6 is a perspective view of a porous aluminum housing of the apparatus of FIG. 5;

FIG. 7 is a cutaway perspective view of the apparatus of FIG. 5;

FIG. 8 is a schematic representation of another exemplary embodiment of an apparatus employing a porous material as a housing and having one microphone;

FIG. 9 is a block diagram of a microphone receiving sound and elements for the processing of the received sound;

FIG. 10 is a graphical representation showing a simulated response of a typical microphone integration; and

FIG. 11 is a graphical representation showing a simulated response of a microphone integration having a device housing with a porous metal surface.

### DETAILED DESCRIPTION OF EMBODIMENT

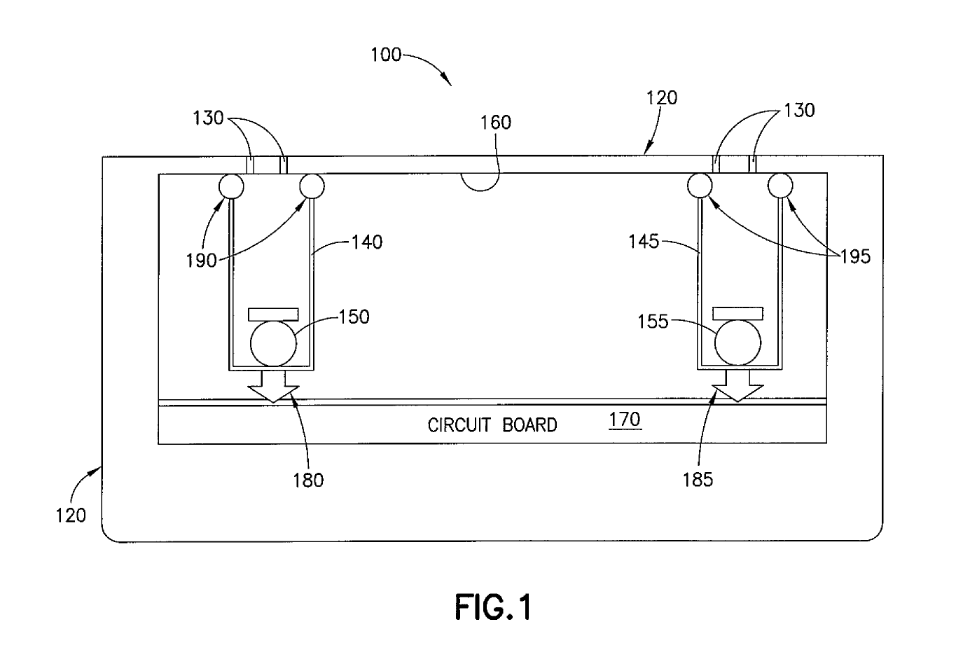

Referring to FIG. 1, one exemplary embodiment of an apparatus showing an integration of a microphone configuration therein is designated generally by the reference number 100 and is hereinafter referred to as “apparatus 100.” In apparatus 100, a housing 120 includes a plurality of holes 130 therein through which sound can be received. As shown, a first microphone housing 140 and a second microphone housing 145 may be located in the housing 120, each microphone housing 140, 145 containing a respective first microphone 150 and second microphone 155, and each microphone housing 140, 145 being sealed along an inner surface 160 of the housing 120 such that sound may be received through one or more holes 130 into the first microphone housing 140 and through one or more additional holes 130 into the second microphone housing 145. The first microphone 150 may be operably coupled to a circuit board 170 via a first connection 180, and the second microphone 155 may be operably coupled to the circuit board 170 via a second connection 185. One or both of the first connection 180 and the second connection 185 may be flexible, such as wiring through flexible tubing. The first microphone 150 and the second microphone 155 are not limited to being operably coupled to the circuit board 170, however, as the microphone(s) may be coupled to a chassis or any other element of the apparatus 100.

This integration of microphones into an apparatus generally involves a precision placement and coupling of the first microphone 150 (and the first microphone housing 140) to the second microphone 155 (and the second microphone housing 145). Precision placement of the microphones 150, 155 is desirable so as to ensure that the microphones 150, 155 correspond with the proper locations of the holes 130. Additionally, a first seal 190 sealing the first microphone housing 140 to the inner surface 160 of the housing 120 is separate from a second seal 195 sealing the second microphone housing 145 to the inner surface 160 of the housing 120 in order to avoid sound received in the first microphone housing 140 being “leaked” into the second microphone housing 145. However, precisely placing the microphones 150, 155 and sealing the microphone housings 140, 145 generally undesirably adds to an overall cost of assembly of the apparatus 100.

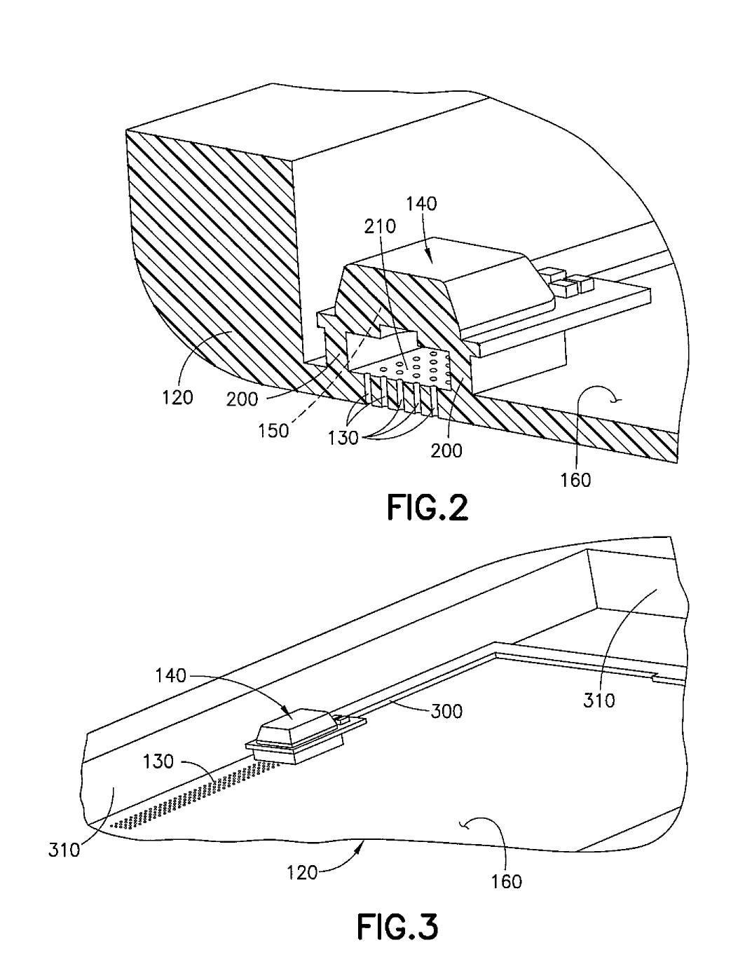

Referring to FIG. 2, the first microphone housing 140 may comprise walls 200 that extend perpendicularly from the inner surface 160 of the housing 120, the walls 200 configured to define a sound cavity 210 and arranged to surround a plurality of the holes 130. The walls 200 may be sealed to the inner surface 160 using a suitable adhesive, ultrasonic welding, or any other suitable means of sealing, or they may be integrally formed with the inner surface 160 of the housing 120. The first microphone 150 in the microphone housing 140 may be located distally from the holes 130 such that sound received into the sound cavity 210 has a particular quality. The second microphone housing 145 may be similarly configured, or it may be configured to be different.

Referring to FIG. 3, the first microphone 150 in the first microphone housing 140 may be operably coupled to the circuit board 170 using a flexible member 300. As shown, the flexible member 300 may extend along joints defined by walls 310 and the inner surface 160 of the housing 120 as well as across the inner surface 160 of the housing 120.

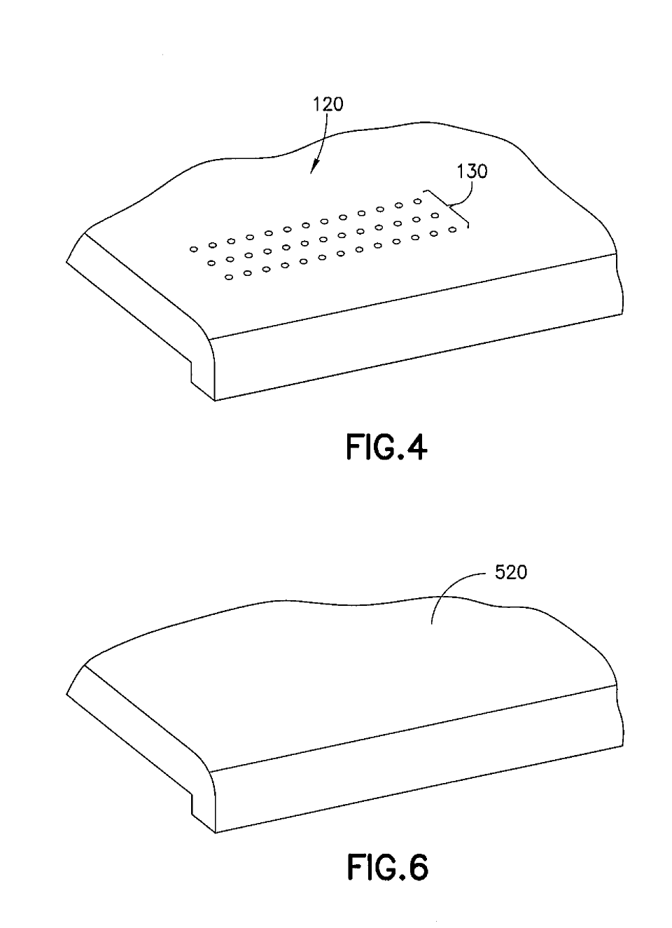

Referring to FIG. 4, a configuration of the holes 130 in the housing 120 is shown. The holes 130 may be arranged in a rectangular array, as shown, or they may be arranged in a circular pattern, an oval pattern, or any other suitable pattern.

Referring now to FIG. 5, another exemplary embodiment of an apparatus showing an integration of a microphone configuration therein is designated generally by the reference number 500 and is hereinafter referred to as “apparatus 500.” Apparatus 500 may be a camera (e.g., a virtual reality (VR) camera, a camera having a wide-angle lens, a camera having multiple lenses, or the like), a tablet, a mobile phone, or the like. Although the features will be described with reference to the example embodiments shown in the drawings, it should be understood that features can be embodied in many alternate forms of embodiments. In addition, any suitable size, shape, or type of elements or materials could be used.

Apparatus 500 comprises at least two microphones, namely, a first microphone 550 and a second microphone 555, each located on a circuit board 570 in a chassis 510 and each capable of receiving sound waves (sound) from an environment outside the apparatus 500 and through a housing 520 having a porosity. The housing 520 may be a cover having a porosity, such a cover being a lid or other member for the apparatus through which the sound may be received. A processor 940 may be located on the circuit board 570. Although the apparatus 500 is described as receiving the sound through the housing 520 or cover, one of ordinary skill in the art would understand that the chassis 510 may also have a porosity and that sound may be received through the chassis 510.

The apparatus 500 is configured to enable the capture of sound at the first microphone 550 and the second microphone 555. The sound may be received into the apparatus 500 through respective sound inlets in the housing 520, the sound inlets being pores of a material from which the housing 520 is fabricated. The sound inlets are too small to be discernible by the user (and are therefore substantially invisible). The sound inlets are also not mechanically coupled to the first microphone 550 or the second microphone 555 due to such mechanical coupling being generally difficult and expensive to manufacture, the sound inlets being easily blocked by the user's hand, and the sound inlets being sensitive to wind and handling noise.

In the apparatus 500, the first microphone 550 and the second microphone 555 may be assembled directly to the circuit board 570, thus obviating the need for a flexible connection of the microphones 550, 555 to the circuit board 570. Each of the first microphone 550 and the second microphone 555 may include a microphone housing and front/back chambers as desired. Each microphone 550, 555 may also be of the “top port” type. The first microphone 550 and the second microphone 555 may not be sealed (e.g., mechanically coupled) to an inner surface 560 of the housing 520 to enable sound to be received through the same portion of the housing 520 and picked up by either or both microphones 550, 555.

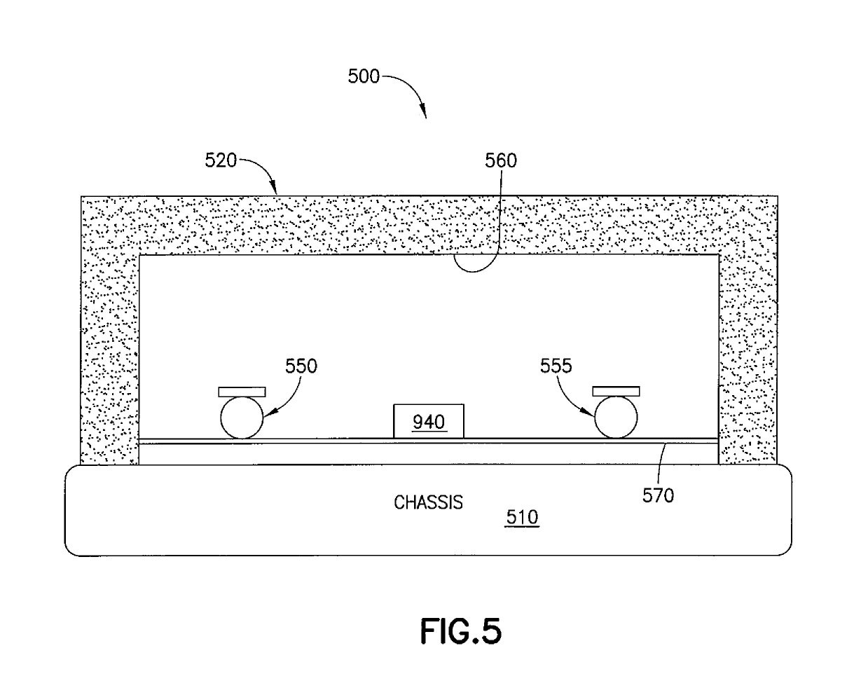

Referring to FIG. 6, the housing 520 may be a porous structural element with the pores through which the sound is received being too small to be discernible. The housing 520 may be made of one or more different materials. In one exemplary embodiment, the material of the housing 520 comprises aluminum having a porosity sufficient to allow for the passing of sound waves. The housing 520 is not limited to being aluminum, however, as other materials may be used (e.g., aluminum alloys, metal foams such as aluminum foam, and the like). In exemplary embodiments in which aluminum is used as the material for the housing 520, the aluminum may have a porosity of 50% or greater and nominal pore sizes of about 50 micrometers (um) in diameter to about 600 um in diameter. In some exemplary embodiments, the nominal pore sizes are about 100 um in diameter. Furthermore, the pores may be tortuous throughout, the aluminum (or other material) such that light does not pass through. Additionally, the porosity may be defined by an arrangement of pores that creates a design illusion that may or may not be detectable by the user. The housing 520 may also be of sufficient size such that the user cannot inadvertently block all of the sound received through the housing 520.

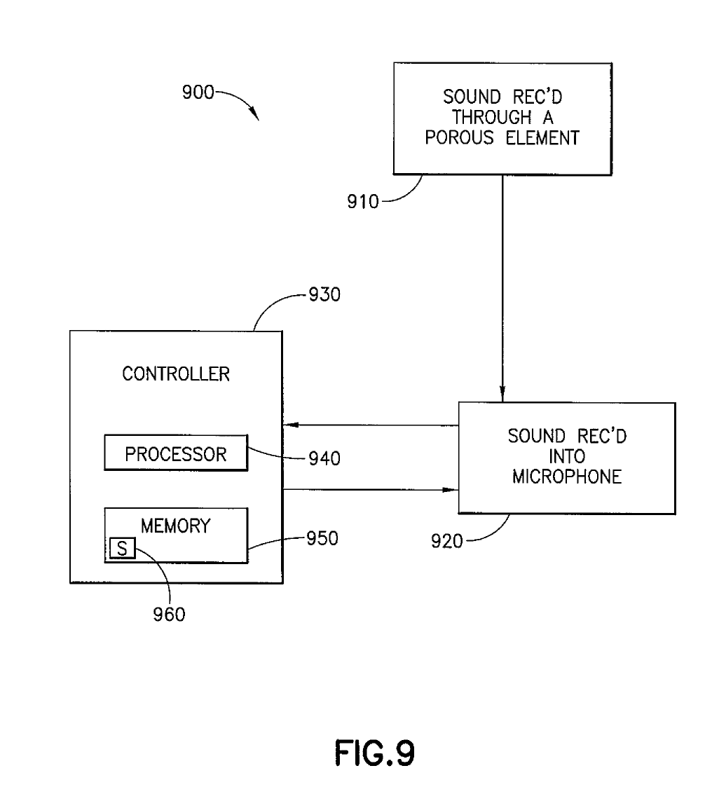

The housing 520 and the porosity thereof may have an effect on frequency characteristics of sound passing through the housing 520. For example, the porosity, pore size, and/or material of the housing 520 may cause higher frequencies to be attenuated more than lower frequencies. One or both of the first microphone 550 and the second microphone 555 may be configured to counter this effect by amplifying higher frequencies. Furthermore, it may be possible to counter this effect using the processor 940 (also shown in FIG. 9) to filter or otherwise process an output from one or both of the first microphone 550 and the second microphone 555 using a digital filter.

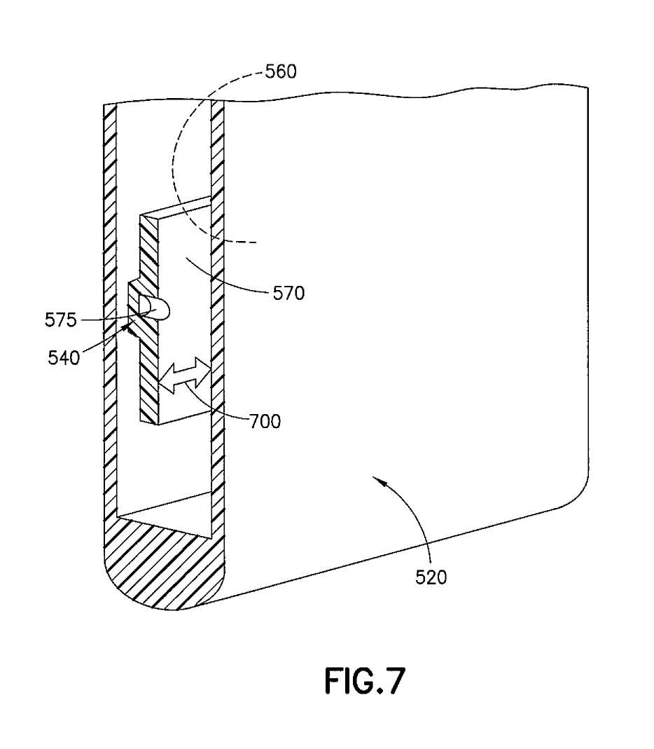

Referring now to FIG. 7, an air gap 700 is shown between a microphone 550 and the inner surface 560 of the housing 520. The microphone 550 may be disposed in a microphone housing and may be connected directly to the circuit board 570, thus obviating the need for a flexible connection between the microphone 550 and the circuit board 570. A hole 575 in the circuit board 570 operates as an inlet and facilitates the passing of sound from the air gap 700 to the microphone 550. In the alternative, the microphone 550 (and/or a second microphone) may be mounted to the circuit board 570 on the side facing the inner surface 560 of the housing 520. In any embodiment, however, the microphone 550 may not be sealed to the inner surface 560 of the housing 520.

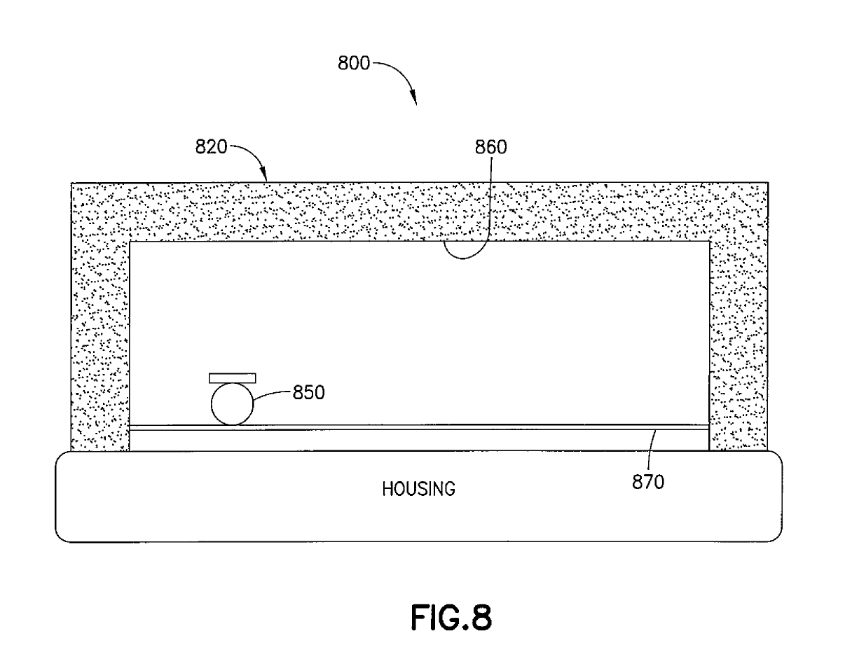

Referring now to FIG. 8, another exemplary embodiment of an apparatus showing an integration of a microphone configuration therein is designated generally by the reference number 800 and is hereinafter referred to as “apparatus 800.” Apparatus 800 may be a camera (e.g., a VR camera), a tablet, a mobile phone, or the like.

Apparatus 800 comprises one internal microphone, namely, a microphone 850, located on a circuit board 870 and capable of receiving acoustic signals from an environment outside the apparatus 800 and through a housing 820. As with apparatus 500, the apparatus 800 is configured to enable the capture of sound into the microphone 850 through respective sound inlets in the housing 820, the sound inlets in the housing 820 being too small to be discernible (and therefore substantially invisible) and not mechanically coupled to the microphone 850. Also as with apparatus 500, the housing 820 in apparatus 800 may be porous. Materials from which the housing 820 may be fabricated include, but are not limited to, aluminum, aluminum alloys, metal foams, and the like. As with the apparatus 500, the microphone 850 may not be directly connected to an inner surface 860 of the housing 820.

Referring now to FIGS. 5 through 7, the microphones 550, 555 employed do not utilize large, visible holes in the housing 520, such holes generally detracting from the aesthetic appearances of the apparatus 200, because the entire housing 520 is fabricated of the porous material with substantially non-discernible (virtually invisible) holes that audio can pass through. Furthermore, the user cannot block the entire-housing 520 with their hands, and therefore the microphones 550, 555 cannot be undesirably blocked. Moreover, the microphones 550, 555 can be integrated directly onto the circuit board 570, which is less expensive and generally more reliable than the use of seals, flex connections, and the like. Additionally, the porosity of the housing 520 may contribute to a reduction in noise due to wind and/or other environmental factors, at least in some situations. Still further, handling noise may be reduced due to the microphones 550, 555 not being physically connected to the housing 520. Similar advantages may be realized in an apparatus employing only one microphone.

Referring now to FIG. 9, a method of receiving sound for use with a camera, VR camera, tablet, mobile phone, or other electronic device is shown generally at 900 and is hereinafter referred to as “method 900.” In method 900, sound is received through a porous housing of an electronic device, as shown in step 910. The sound is picked up by a microphone, as shown in step 920. Although step 920 illustrates that the sound is picked up by one microphone, the sound may be picked up by two or more microphones located in or otherwise associated with the electronic device. The sound picked up by the microphone(s) may then be processed using a controller 930 having a processor 940 and a memory 950. The memory 950 may include software 960 and may store the processed sound. Processed sound may then be used for any suitable application associated with the electronic device, e.g., as a sound file for recorded audio content, as filtered audio for a user of the electronic device or any other user to which the filtered audio is transferred, as a simple audio output, or the like.

### EXAMPLE

### Case A

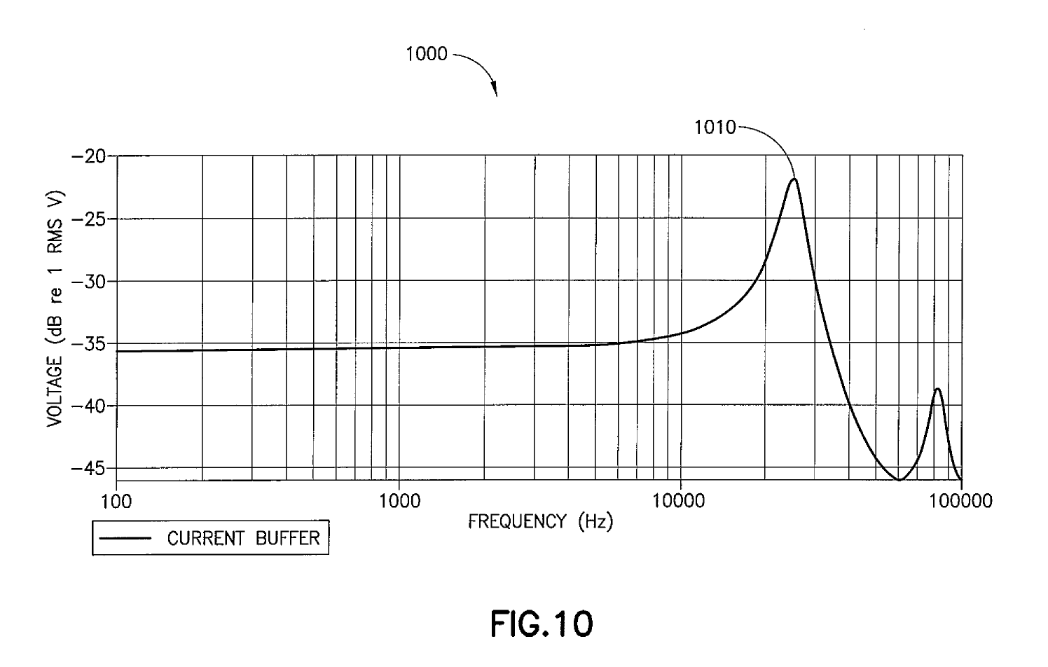

A comparison simulation with ARES LPM (lumped parameter method) acoustic simulation tool (available from McIntosh Applied Engineering, LLC, Eden Prairie, Minn., USA) was performed. In a typical microphone integration, a microphone was integrated into a device housing, the microphone being a typical 3×4×1 millimeters (mm) MEMS (microelectrical-mechanical system) microphone such as a Knowles brand microphone (available from Knowles, Itasca, Ill., USA). In such a microphone, the sound port length was 1 mm, and the sound port diameter was also 1 mm. A typical ideal integration in a high-quality audio device was achieved. As shown in FIG. 10, a simulated response is shown generally at 1000. The simulated response 1000 has a resonance peak 1010 at 25 kilo Hertz (kHz), with the highest frequencies above that peak being attenuated.

### EXAMPLE

### Case B

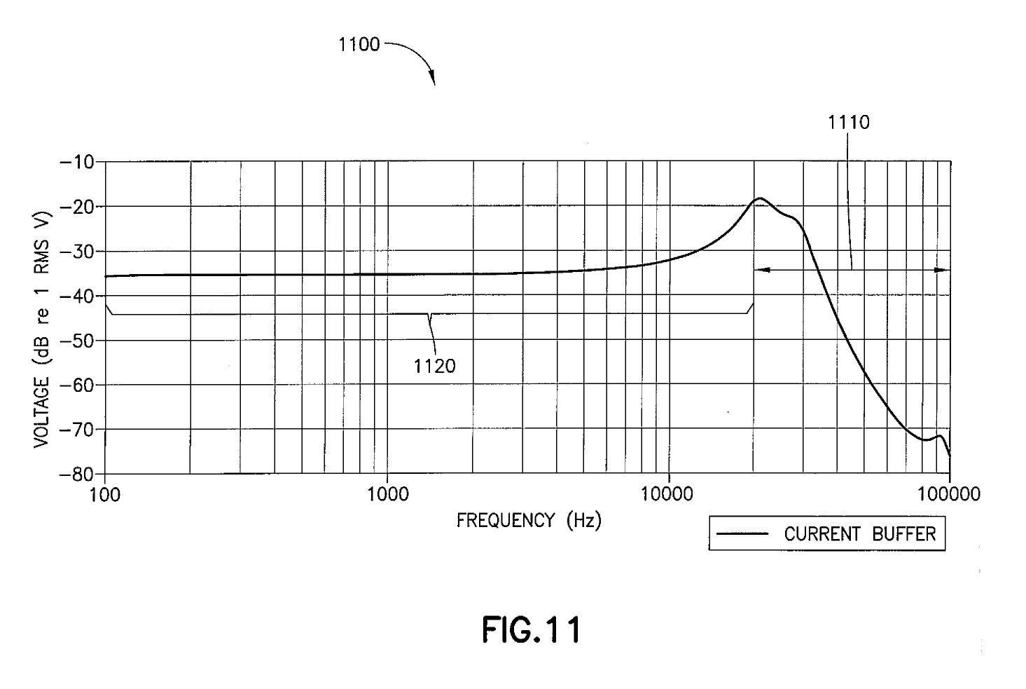

A microphone integration with a porous metal surface, as with regard to the present exemplary embodiments described herein, was also performed. In such an integration, the same type of microphone as in Case A was integrated into a main printed wiring board (PWB) of a device. The device housing was 3×7×1 centimeters (cm) (the device was a small consumer electronics device (a camera)) having an open air volume of approximately 10% of the total cavity size, which was approximately 2 cubic centimeters. The housing of the device was made of porous metal and had small pores in the surfaces thereof, such pores operating as sound ports. A porosity of the metal was 50%, the material thickness was 0.5 mm, the pore size was 0.14 mm, and the number of pores was about 12,500. As shown in FIG. 11, a simulated response is shown generally at 1100, with simulated results showing that (1) simulated response had an equal overall sensitivity in the range 1110 as compared to a reference integration; and (2) simulated response had an equally flat frequency behavior in the operation range of 100 Hz to 20 kHz (shown at 1120). Therefore, according to the simulation, the acoustic parameters of the exemplary embodiment of the present invention would be as good as high quality prior art designs.

With regard to both Case A and Case B, the simulation results also revealed that putting microphones on the PWB and using one or a small number of holes in the housing instead of porous material would be detrimental to the operations of the apparatus. In the Case A scenario, if the microphone was integrated into the PWB and it was not mechanically coupled to the housing and the housing had a single large inlet tube (or a few smaller tubes) through the housing, results were less than optimal. However, in a Helmholz resonator the air in the tube corresponded to a resistance, and the air space between the housing and the PWB corresponded to a capacitance. The air space was large compared to the tube, and this pushed the resonance into lower frequencies that caused problems to the microphone frequency response. In the exemplary embodiments of the present invention as described herein, the large number of small pores effectively changed the ratio in the Helmholz resonator, and the problem disappeared even though the microphones were on the PWB and had no mechanical coupling to the housing. In practice, this may only work when a porous material is used, because only in a porous material enough pores (inlets) can be produced cheaply. Drilling or laser drilling substantial amounts of inlets may be prohibitively expensive.

Referring now to all of the Figures and Examples described herein, any of the foregoing exemplary embodiments may be implemented in software, hardware, application logic, or a combination of software, hardware, and application logic. The software, application logic, and/or hardware may reside in the apparatus 500 (or apparatus 800 or other device) to detect sound through a porous structure for subsequent processing. If desired, all or part of the software, application logic, and/or hardware may reside at any other suitable location. In an example embodiment, the application logic, software, or an instruction set is maintained on any one of various computer-readable media. A “computer-readable medium” may be any media or means that can contain, store, communicate, propagate, or transport instructions for use by or in connection with an instruction execution system, apparatus, or device, such as a computer. A computer-readable medium may comprise a computer-readable storage medium that may be any media or means that can contain or store the instructions for use by or in connection with an instruction execution system, apparatus, or device, such as a computer.

In one exemplary embodiment, an apparatus comprises a housing, the housing having a porosity comprising pores that are substantially non-discernible to a user such that sound waves from an outside of the housing can be received at an inside of the housing; at least one microphone located at the inside of the housing and configured to receive the sound waves via acoustic connection to the outside of the housing; a processor for processing the sound waves received by the at least one microphone; and a memory for storing the processed sound waves as a file. The at least one microphone is not mechanically coupled to the pores.

In the apparatus, the at least one microphone may comprise at least two microphones. The porosity of the housing may be defined by pores from about 50 um in diameter to about 600 um in diameter. The porosity of the housing may be 50% or greater. A material of the housing may comprise aluminum. A material of the housing may be a metal. The at least one microphone may be configured to amplify a higher frequency of the sound waves received at the inside of the housing. The processor may further comprise a digital filter for filtering outputs from the at least one microphone to counter attenuation of higher frequencies of the sound waves received at the inside of the housing. The apparatus may be a camera, a virtual reality camera, a camera having a wide-angle lens, a camera having two or more lenses, a tablet, or a mobile phone.

In another exemplary embodiment, an apparatus comprises at least one processor; and at least one non-transitory memory including computer program code, the at least one memory and the computer program code configured to, with the at least one processor, cause the apparatus at least to perform: detecting a sound from a first side of a porous material comprising pores that are substantially non-discernible to a user through the porous material at an opposing second side of the porous material; receiving the sound into at least one microphone at the opposing second side of the porous material via acoustic connection to the first side of the porous material; and processing the received sound at the at least one processor. The at least one microphone is not mechanically coupled to the pores.

In the apparatus, the at least one microphone may comprise at least two microphones. A porosity of the porous material may be defined by pores from about 50 um in diameter to about 600 um in diameter. A porosity of the housing may be 50% or greater. A material of the housing may comprise aluminum. A material of the housing may be a metal.

In another exemplary embodiment, a method comprises detecting a sound from a first side of a porous material comprising pores that are substantially non-discernible to a user through the porous material at an opposing second side of the porous material; receiving the sound into at least one microphone at the opposing second side of the porous material via acoustic connection to the first side of the porous material; and processing the received sound at the at least one processor. The at least one microphone is not mechanically coupled to the pores.

In the method, a porosity of the porous material may be defined by pores from about 50 um in diameter to about 600 um in diameter. A material of the housing may comprise aluminum. The method may further comprise amplifying a higher frequency of the sound received at the opposing second side of the porous material. The method may further comprise means for filtering an output from one or more of the at least one microphone to counter attenuation of higher frequencies of the sound received at the opposing second side of the porous material.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications, and variances which fall within the scope of the appended claims.

1. An apparatus, comprising:
a housing, the housing having a porosity comprising pores such that sound waves from an outside of the housing can be received at an inside of the housing;
at least one microphone located at the inside of the housing and configured to receive the sound waves via acoustic connection to the outside of the housing by receiving the sound waves through the pores, from the inside of the housing, and configured to receive all of the received sound waves from the inside of the housing across an air gap to the at least one microphone;
a processor for processing the sound waves received by the at least one microphone; and
a memory for storing the processed sound waves as a file;
wherein the at least one microphone is not mechanically coupled to the pores.

2. The apparatus of claim 1, wherein the at least one microphone comprises at least two microphones.

3. The apparatus of claim 1, wherein the porosity of the housing is defined by pores from about 50 um in diameter to about 600 um in diameter.

4. The apparatus of claim 1, wherein the porosity of the housing is 50% or greater.

5. The apparatus of claim 1, wherein a material of the housing comprises aluminum.

6. The apparatus of claim 1, wherein a material of the housing is a metal.

7. The apparatus of claim 1, wherein the at least one microphone is configured to amplify a higher frequency of the sound waves received at the inside of the housing.

8. The apparatus of claim 1, wherein the processor further comprises a digital filter for filtering outputs from the at least one microphone to counter attenuation of higher frequencies of the sound waves received at the inside of the housing.

9. The apparatus of claim 1, wherein the apparatus is a camera, a virtual reality camera, a camera having a wide-angle lens, a camera having two or more lenses, a tablet, or a mobile phone.

10. An apparatus, comprising:
at least one processor; and
at least one non-transitory memory including computer program code, the at least one memory and the computer program code configured to, with the at least one processor, cause the apparatus at least to perform:
detecting a sound from a first side of a porous material comprising pores through the porous material at an opposing second side of the porous material;
receiving the sound from the opposing second side of the porous material via acoustic connection to the first side of the porous material by receiving the sound through the pores, from the opposing second side of the porous material, and by receiving all of the received sound from the opposing second side of the porous material across an air gap to the at least one microphone; and
processing the received sound at the at least one processor;
wherein the at least one microphone is not mechanically coupled to the pores.

11. The apparatus of claim 10, wherein the at least one microphone comprises at least two microphones.

12. The apparatus of claim 10, wherein a porosity of the porous material is defined by pores from about 50 um in diameter to about 600 um in diameter.

13. The apparatus of claim 10, wherein a porosity of the housing is 50% or greater.

14. The apparatus of claim 10, wherein a material of the housing comprises aluminum.

15. The apparatus of claim 10, wherein a material of the housing is a metal.

16. A method, comprising:
detecting a sound from a first side of a porous material comprising pores through the porous material at an opposing second side of the porous material;
receiving the sound from the opposing second side of the porous material via acoustic connection to the first side of the porous material by receiving the sound through the pores, and receiving all of the received sound from the opposing second side, and across an air gap to the at least one microphone; and
processing the received sound at the at least one processor;
wherein the at least one microphone is not mechanically coupled to the pores.

17. The method of claim 16, wherein a porosity of the porous material is defined by pores from about 50 um in diameter to about 600 um in diameter.

18. The method of claim 16, wherein a material of the housing comprises aluminum.

19. The method of claim 16, further comprising amplifying a higher frequency of the sound received at the opposing second side of the porous material.

20. The method of claim 16, further comprising means for filtering an output from one or more of the at least one microphone to counter attenuation of higher frequencies of the sound received at the opposing second side of the porous material.
